(19) United States
(12) Patent Application Publication
(10) Pub. No.: US 2009/0025262 A1
(43) Pub. Date: Jan. 29, 2009

(54) License Plate Tear Away

(76) Inventor: Kirk Price, Carterville, IL (US)

Correspondence Address: WILSON DANIEL SWAYZE, JR., 3804 CLEARWATER CT., PLANO, TX, 75025, US

(21) Appl. No.: 11/782,794

(22) Filed: Jul. 25, 2007

(51) Int. Cl. G09F 3/10

(52) U.S. Cl. 40/209

(57) ABSTRACT

A cover member for protecting a license plate includes a tear away refill package having at least a first sheet, and a tear away frame member to be mounted on the license plate. The tear away frame member includes a mounting member to mount the tear away refill package. The first sheet includes a first tab, and the tear away refill package includes a second sheet. The second sheet includes a second tab which is staggered from the first tab. The mounting member includes a tear away pin member, and the tear away pin member includes a main body. The tear away pin member includes a upwardly projecting member, and the upwardly projecting member includes a reduced diameter member. The upwardly projecting member includes an enlarged diameter member, and the tear away frame member includes a back frame member. The back frame member includes a mounting aperture.

### FIELD OF THE INVENTION

The present invention generally relates to a transparent protective cover member for a vehicle license plate and more particularly to a novel construction for such cover member exhibiting distinctive performance advantages when mounted on the vehicle.

### BACKGROUND OF THE INVENTION

For years, vehicles including trucks, cars and motorcycles have been required to display license plates. These license plates, usually dictated by a governing authority, serve as unique identifiers of specific vehicles to the appropriate policing authorities. As such, all states require that the license plate be displayed notoriously while the vehicle is on the roads and highways.

Commonly employed vehicle license plate covers enabling visual observation of the license plate disposed thereunder are now constructed having a generally rectangular physical configuration and with each major surface residing in a substantially single flat plane. Such cover members can be formed with various visually transparent materials such as glass compositions or synthetic organic polymers to permit quick identification of the underlying license plate as required under existing motor vehicle laws. A wide assortment of such flat face cover members has also long been known frequently involving a rather complex physical construction as well as requiring multiple diverse component parts. For example, U.S. Pat. No. 2,807,899 discloses a license cover assembly including a transparent housing member enclosing the license plate with both front and rear flat faces. A still more recently issued U.S. Pat. No. 4,956,930 discloses a license cover assembly employing a plurality of movable transparent flat planar vanes which when closed completely overlies the license plate disposed thereunder while still permitting its visual observation. In still more recently issued U.S. Pat. No. 313,787 there is disclosed a presumably transparent vehicle license plate cover member mounted in a peripherally oriented frame which has an outwardly projecting curved shape joined to the protruding flat side faces.

All of said prior art protective license covers exhibit significant performance drawbacks for a moving vehicle.

U.S. Pat. No. 6,996,459 discloses a transparent vehicle license plate cover member having an outwardly projecting curved shape. The mounted cover enhances aerodynamic operation of the vehicle while reducing glare when viewing the covered license plate.

### SUMMARY

A cover member for protecting a license plate includes a tear away refill package having at least a first sheet, and a tear away frame member to be mounted on the license plate. The tear away frame member includes a mounting member to mount the tear away refill package.

The first sheet includes a first tab, and the tear away refill package includes a second sheet.

The second sheet includes a second tab which is staggered from the first tab.

The mounting member includes a tear away pin member, and the tear away pin member includes a main body.

The tear away pin member includes a upwardly projecting member, and the upwardly projecting member includes a reduced diameter member.

The upwardly projecting member includes an enlarged diameter member, and the tear away frame member includes a back frame member.

The back frame member includes a mounting aperture.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the tear away refill package of the present invention;

FIG. 2 illustrates an exploded view of the tear away refill package of the present invention;

FIG. 3 illustrates a side view of the tear away refill package of the present invention;

FIG. 4 illustrates a cross-sectional view of the tear away frame member of the present invention;

FIG. 5 illustrates a cross-sectional view of the tear away pin member of the present invention;

FIG. 6 illustrates the tear away frame member and the tear away refill pack of the present invention.

### DETAILED DESCRIPTION

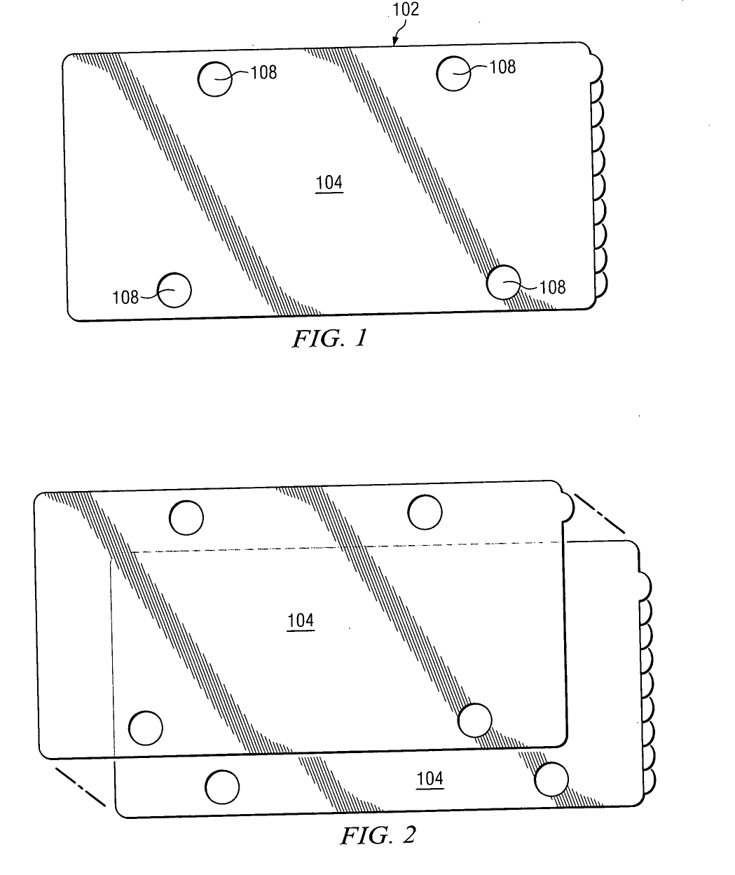

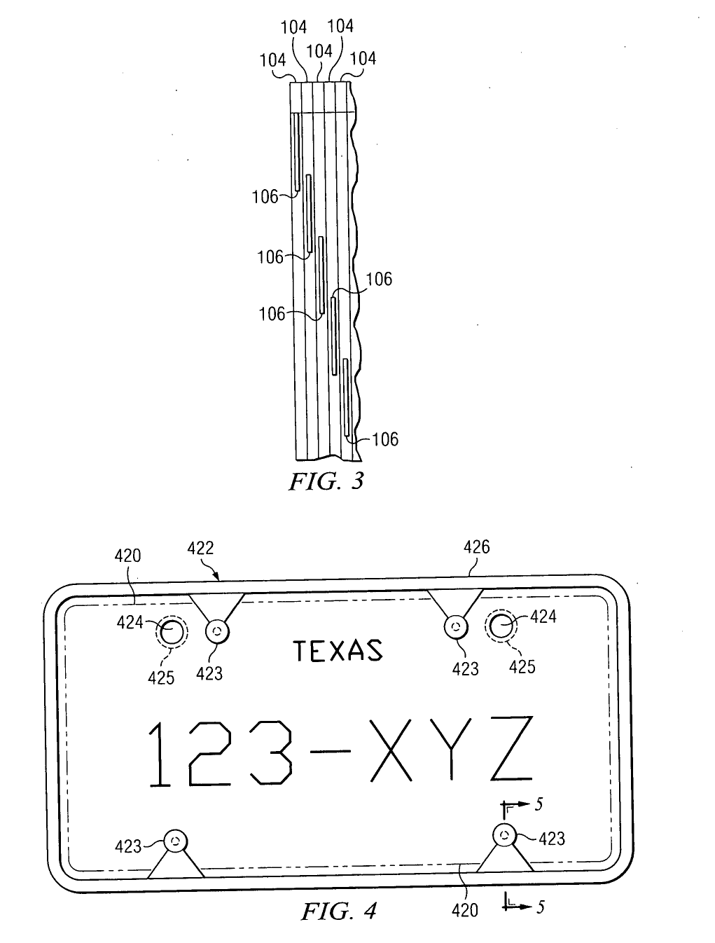

The general physical configuration of the present cover member which includes the tear away refill package and the tear away frame member is substantially rectangular and each being defined by interconnected top, bottom and opposing sides. The cover member of the present invention includes a tear away refillable package member 102 illustrated in FIG. 1 and the tear away frame member 422 illustrated in FIG. 4. The tear away refillable package member 102 includes a plurality of sheets 104 which are transparent which may be as formed from clear plastic or other suitable material and which may be flexible or rigid. The sheets may be positioned in an overlapping relationship. The sheets 104 are substantially rectangular shaped in order to conform to the approximate shape of a license plate 420. The sheets 104 include a mounting aperture 108 in order to be mounted on the outwardly projecting tear away pin member 423. The sheets 104 may be clear or colored. FIG. 1 shows four such mounting apertures 108; however, fewer or more could be incorporated without departing from the scope of the present invention. FIG. 1 additionally shows each sheet 104 having a tab 106 so that when the uppermost sheet 104 becomes soiled, the uppermost sheet 104 can be easily removed to provide a clear view of the license plate. The tab 106 may be staggered with respect to another tab 106 so that the tab 106 for the outermost sheet 104 is positioned slightly higher than the tab 106 of the next lower sheet 104 which includes a tab 106 which is slightly higher or staggered than the 106 of the next lower sheet 104. This staggered positioning of the tabs 106 continues for each sheet 104. FIG. 2 illustrates that the outermost sheet 104 has been removed from the tear away refill package 102 of the present invention. Consequently, the sheets 104 are removed one by one until the tear away refill package 102 is empty. FIG. 3 illustrates a side view of the tear away refill package 102 including the sheets 104 and the tabs 106 which are staggered along the side of the sheets 104. The tabs 106 could be positioned along either side of the tear away refill package 102 or could be positioned along the top would the bottom of the tear away refill package 102.

FIG. 4 illustrates the tear away frame member 422 which is substantially rectangular in shape in order to conform to the outer perimeter of the license plate 420 and which may be formed from a rigid material such as rigid plastic or metal or other suitable material. The license plate 420 includes mounting apertures 424 so that the license plate 420 can be mounted on the automobile or vehicle. The tear away frame member 422 includes a back plate frame member 426 which is formed on the back of the tear away frame member 422 and which includes apertures 425 to be aligned with the mounting apertures 424 to mount the tear away frame member 422 with the license plate 402.

FIG. 4 additionally illustrates a tear away pin member 423 which is used to mount the tear away refill package 102 over the license plate 420. FIG. 4 illustrates a tear away pin member 423 at approximately each corner of the tear away frame member 422; however, other locations for the tear away pin member 423 are within the scope of the present invention.

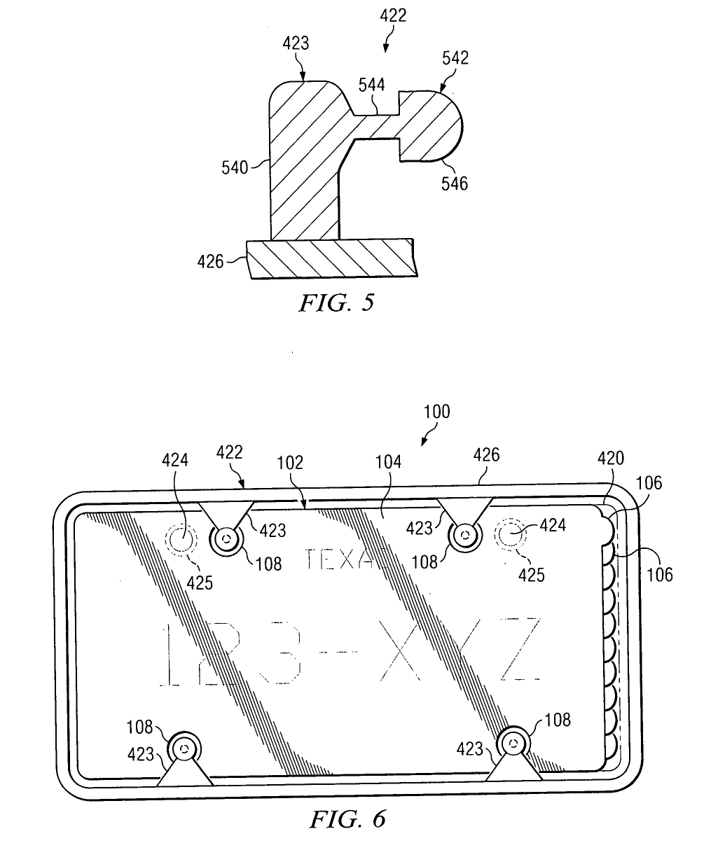

FIG. 5 illustrates a cross-section of the tear away pin member 423 which includes an main body member 540 which extends outward from the tear away frame member 423 and a upwardly projecting member 542 which includes a reduced diameter member 544 and a enlarged diameter member 546 which cooperates with the mounting aperture 108 of the sheets 104 so that the sheets 104 are not prematurely removed from the tear away refill package 102.

FIG. 6 illustrates the cover member 100 of the present invention. The cover member 100 includes a tear away refill package 102 which includes sheets 104 having a tab 106. The tear away refill package 102 includes mounting apertures 108 to be mounted on the tear away pin member 423 of the tear away frame member 422. The tear away frame member 422 includes a back plate frame member 426 having apertures 425 to cooperate with the mounting apertures 424 of the license plate 420. The tear away frame member 422 includes the tear away pin member 423 to mount the tear away refill package 102.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A cover member for protecting a license plate, comprising:
a tear away refill package having at least a first sheet;
a tear away frame member to be mounted on the license plate;
wherein the tear away frame member including a mounting member to mount the tear away refill package.

2) A cover member for protecting a license plate as in claim 1, wherein the at least the first sheet includes a first tab.

3) A cover member for protecting a license plate as in claim 1, wherein the tear away refill package includes a second sheet.

4) A cover member for protecting a license plate as in claim 3, wherein the second sheet includes a second tab which is staggered from the first tab.

5) A cover member for protecting a license plate as in claim 1, wherein the mounting member includes a tear away pin member.

6) A cover member for protecting a license plate as in claim 5, wherein the tear away pin member includes a main body.

7) A cover member for protecting a license plate as in claim 6, wherein the tear away pin member includes a upwardly projecting member.

8) A cover member for protecting a license plate as in claim 7, wherein the upwardly projecting member includes a reduced diameter member.

9) A cover member for protecting a license plate as in claim 8, wherein the upwardly projecting member includes a enlarged diameter member.

10) A cover member for protecting a license plate as in claim 1, wherein the tear away frame member includes a back frame member.

11) A cover member for protecting a license plate as in claim 10, wherein the back frame member includes a mounting aperture to cooperate with a mounting aperture of the license plate.
